(19) United States
(12) Patent Application Publication
(10) Pub. No.: US 2005/0201640 A1
(43) Pub. Date: Sep. 15, 2005

(54) DIGITAL PICTURE SCALING

(76) Inventor: Wen-Kuo Lin, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,551

(22) Filed: Mar. 10, 2004

(51) Int. Cl. G06K 9/00

(52) U.S. Cl. 382/298

(57) ABSTRACT

A method for scaling a digital picture to generate a plurality of different size pictures includes following steps: (a) providing a scaling engine; (b) loading a section of the digital picture to the scaling engine; and (c) scaling the section loaded in step (b) to generate digital images of different sizes.

### BACKGROUND OF INVENTION

1. Field of the Invention

The present invention relates to scaling digital pictures, and more particularly, to scaling digital pictures to generate a plurality of different size pictures at a time with one scaling engine.

2. Description of the Prior Art

Digital pictures very often need to be scaled to a number of sizes simultaneously in order to fit a number of applications. For instance, one section of a digital picture is scaled up to mimic the zoom-in effect and at the same time it needs to be scaled down in order to be displayed on a smaller size screen.

Please refer to FIG. 1. FIG. 1 is a schematic diagram of the first method for scaling a picture into a number of sizes according to the prior art. Conventionally, scaling pictures into a number of sizes is performed by two methods. The first method is to use one scaling engine to scale the picture into one size at a time. Firstly, the picture is loaded to the scaling engine and scaled to one size. After that, the picture is re-loaded to the scaling engine and scaled to another size. Therefore, to scale a picture into a multiple sizes, the procedures of loading the picture into the scaling engine, performing scaling and outputting the results are repeated multiple times depending on the target sizes required. The benefit of the first method is that only one set of buffer memory and one scaling engine are required. However, the drawback for the fist method is that it takes longer time to complete the scaling process. Therefore, the fist method is not suitable for applications in which execution time is a critical issue. Alternatively, a more powerful scaling engine can be used to shorten the processing time, but it adversely increases the implementation costs, as well as the power consumption.

Please refer to FIG. 2. FIG. 2 is a schematic diagram of a second method for scaling a picture into a number of sizes according to the prior art. For the second method, a number of scaling engines are used. Each scaling engine loads the original picture and performs the scaling process for one size only. The benefit for the second method is that the scaled results of different sizes can be output simultaneously, so the second method is suitable for real-time applications. Nevertheless, since a number of scaling engines are used and each scaling engine requires its own buffer memory to store the loaded original picture, it will require a large amount of hardware circuits and memory space to implement the second scaling method. Consequently, the second scaling method is costly and has high runtime power consumption. Furthermore, the second scaling method is only suitable for the desktop computers. Whereas, for portable devices the second scaling method will not be applicable as the hardware complexity and power consumption are two of the major design issues.

From above-mentioned, the first scaling method is low cost but slow, and the second scaling method is fast but requires high hardware complexity and power consumption. Therefore, a method that can perform fast scaling and be implemented with simple hardware is required.

### SUMMARY OF INVENTION

It is therefore a primary objective of the claimed invention to provide a method for scaling a digital picture to generate a plurality of different size pictures at a time with one scaling engine to solve the above-mentioned problem.

According to the claimed invention, a method for scaling a digital picture to generate a plurality of different size pictures comprises the following steps: (a) providing a scaling engine; (b) loading a section of the digital picture to the scaling engine; and (c) scaling the section loaded in step (b) to generate digital images of different sizes.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the first method for scaling a picture into a number of sizes according to the prior art.

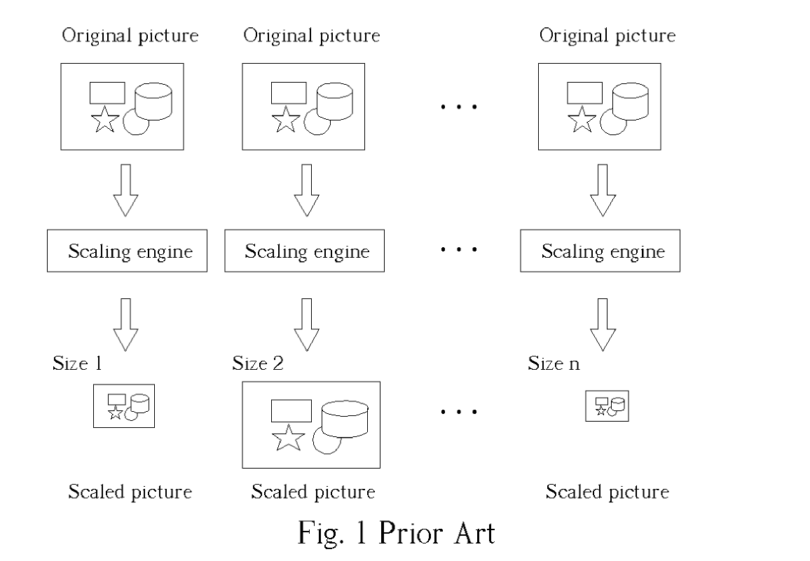

FIG. 2 is a schematic diagram of a second method for scaling a picture into a number of sizes according to the prior art.

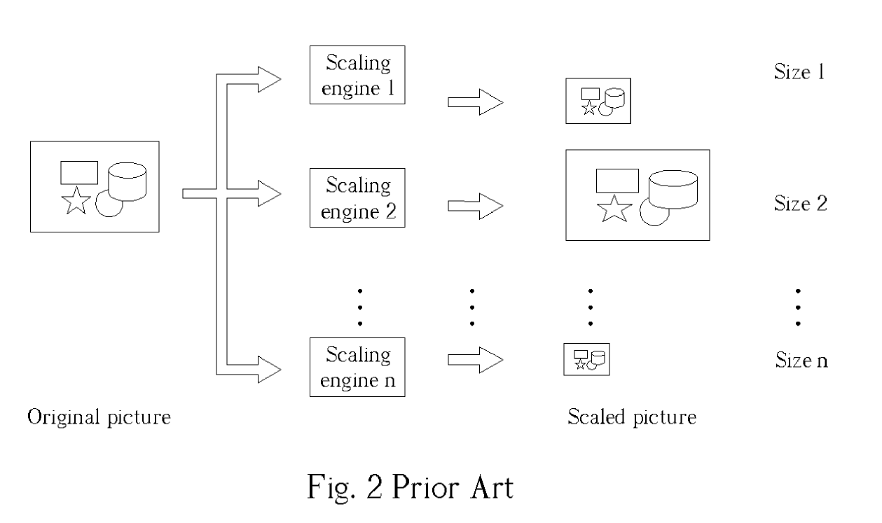

FIG. 3 is a conceptual diagram of a scaling method according to the present invention.

FIG. 4 is a flowchart according to the present invention.

FIG. 5 is a schematic diagram of a scaling method according to the present invention.

FIG. 6 is a flowchart of a preferred embodiment according to the present invention.

FIG. 7 is a schematic diagram of two data sections.

### DETAILED DESCRIPTION

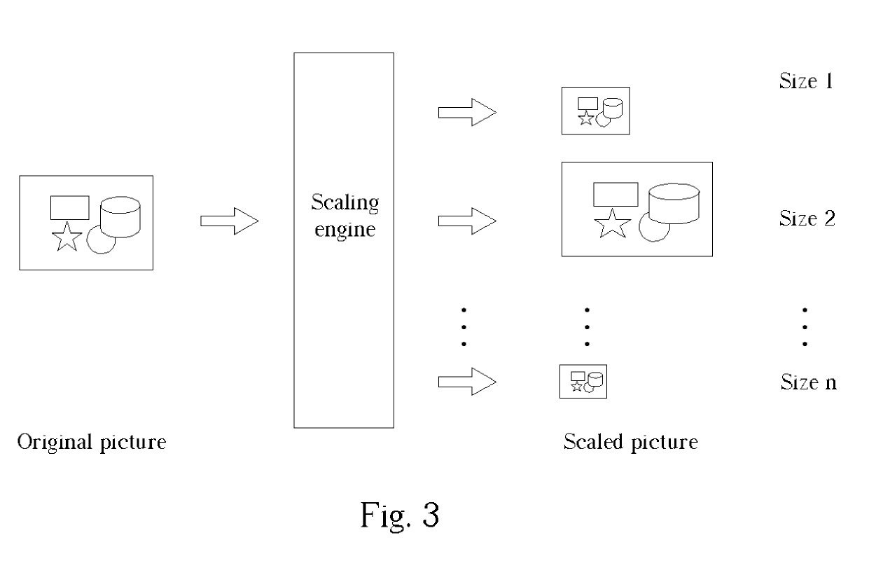

Please refer to FIG. 3. FIG. 3 is a conceptual diagram of a scaling method according to the present invention. Since only one scaling engine is required, the hardware complexity and memory requirement are as low as the first conventional method. However, the scaling method according to the present invention is capable of outputting multiple scaling results simultaneously like the second conventional method. Hence, the scaling method according to the present invention has the advantages of both conventional methods, such as low hard ware implementation complexity, low memory requirement, low power consumption and being adaptable to real-time applications.

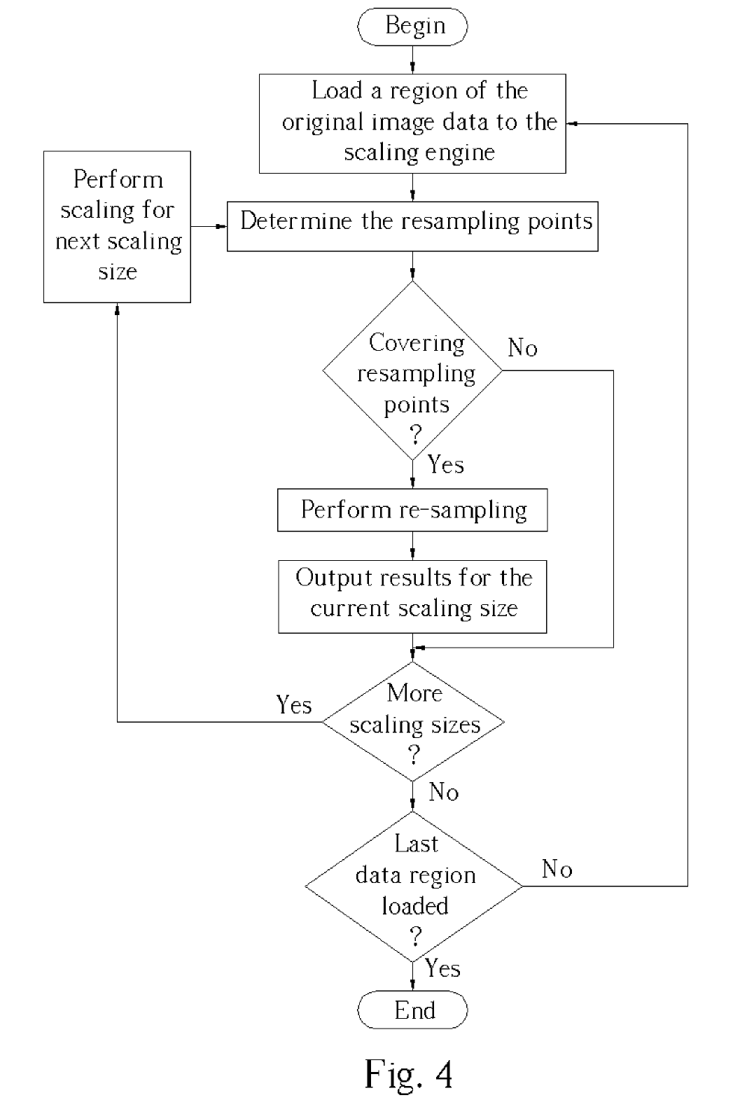

Please refer to FIG. 4. FIG. 4 is a flowchart according to the present invention. Firstly, a section of the original picture is loaded to the scaling engine implementing the present invention. Then, the scaling engine determines whether or not the loaded data section covers re-sampling points to produce the results for a first scaling size. If there are no re-sampling points covered in the current section and there are more sizes to be scaled, the scaling engine determines the re-sampling points for the next size. On the other hand, if there are re-sampling points available, the scaling engine performs the re-sampling process and the results are output for the current scaling size. After that, if there are some more scaling sizes, the scaling engine repeats the procedures of determining the re-sampling points, performing re-sampling process and outputting the results. After the scaling engine finishes the scaling procedures based on the current data section loaded for all sizes, the scaling engine loads a new section of the original picture and repeats the above scaling procedures, if the last section of the original picture is not yet reached.

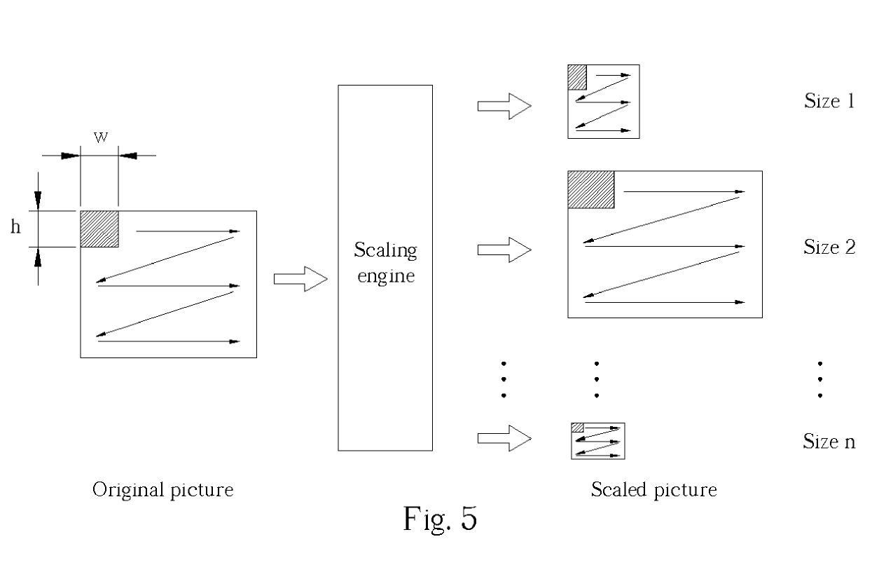

Please refer to FIG. 5. FIG. 5 is a schematic diagram of a scaling method according to the present invention. The shaded area on the original picture represents the amount of data loaded into the scaling engine. Those shaded areas on the scaled pictures represent the amount of data output by the scaling engine. Outputting the results to the scaled pictures is in the raster order as indicated by the arrows. That is, the data section input to the scaling engine begins from the top-left of the original picture and ends at the bottom-right of the original picture. In addition, the dimension of the data section loaded varies depending on the applications, however, the minimum height “h” has to be as long as the vertical interpolation filter and the minimum width “w” has to be as long as the horizontal interpolation filter.

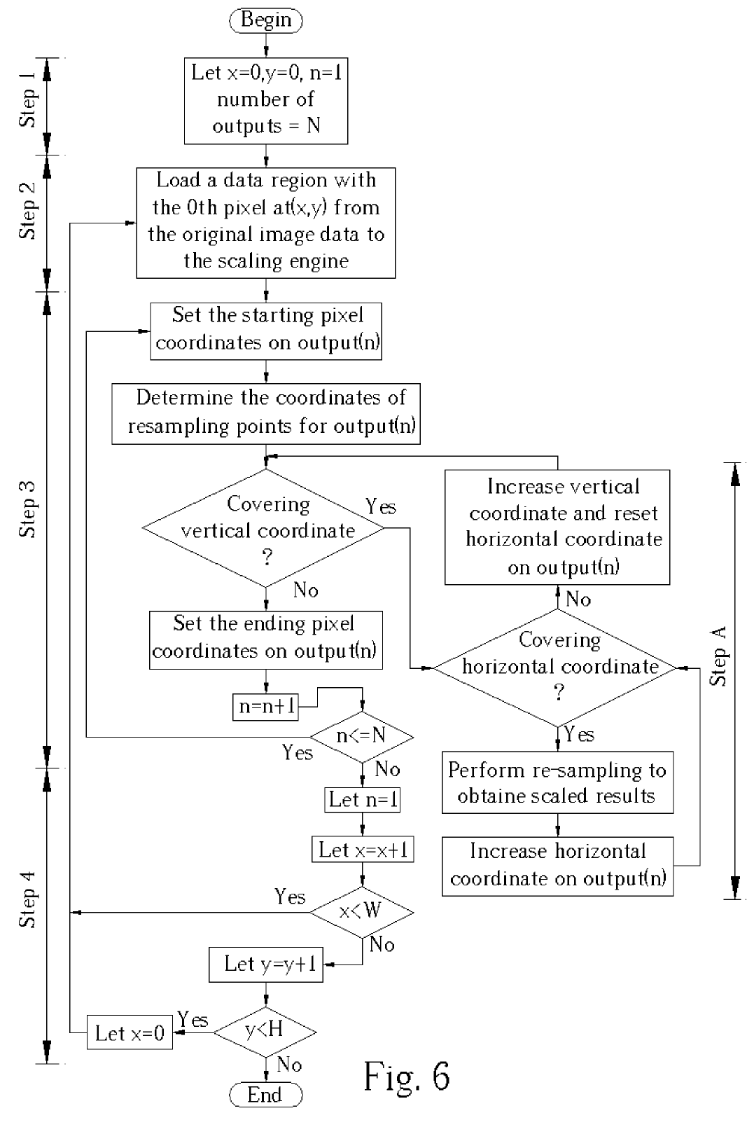

Please refer to FIG. 6. FIG. 6 is a flowchart of a preferred embodiment according to the present invention. The size of the data section used affects the buffer memory requirement as the larger the data section, the more the buffer memory required. Therefore, for minimizing the buffer memory used by the scaling engine, the buffer dimension is kept to a minimum in the preferred embodiment. That is, if the size of vertical interpolation filter is h taps and the size of horizontal interpolation filter is w taps, the size of buffer memory in the scaling engine becomes (h×w) units. The preferred embodiment is divided into four major steps: In step 1, indexes “x” and “y” are set to 0 and index “n” is set to 1, where “x” and “y” give the coordinates of the 0th pixel on the data section being loaded to the scaling engine, and “n” represents the nth data output Output(n). The total number of data outputs is set to N representing N different scaling sizes. The value of N depends on the application.

In step 2, a data section with 0th pixel at (x,y) from the original picture is loaded into the scaling engine.

In step 3, the starting pixel coordinates corresponding to the data output location on Output(n) are loaded. After that, the scaling engine can then determine whether or not the data section currently loaded covers the coordinates of re-sampling points for Output(n). If the data section covers a vertical coordinate of the re-sampling points, the scaling engine performs procedures in Step A. In Step A, the engine determines whether or not the horizontal coordinates of re-sampling points are covered. If a horizontal coordinate is covered, the scaling engine then performs the re-sampling process and the results are output to corresponding location on Output(n) and the horizontal coordinate on Output(n) is increased by one. These processes continue until no further horizontal coordinates are covered at the current vertical coordinate. The vertical coordinate is then increased by one and the horizontal coordinate is reset to the starting point. The scaling engine performs the above procedures until no further vertical coordinates on Output(n) are covered by the current data section loaded. After that, the ending pixel coordinates are set to the last scaled pixel output to Output(n) and then the index “n” is increased by one. The coordinates of starting and ending pixels can be recoded by maintaining a set of coordinate pointers for each out-put size. At the end, the scaling process returns to the beginning of Step 3 for outputting results of next scaling size. Step 3 finishes after the results for the last scaling size are output, ie. n=N.

In step 4, index “n” is firstly set to 1 and index “x” is in-creased by one. If “x” is still smaller than W (the width of the original picture), the scaling process returns to Step 2; otherwise, index “y” is increased by one. If “y” is smaller than H (the height of the original picture), index “x” is set to 0 and the scaling process returns to Step 2; otherwise, the scaling process is accomplished.

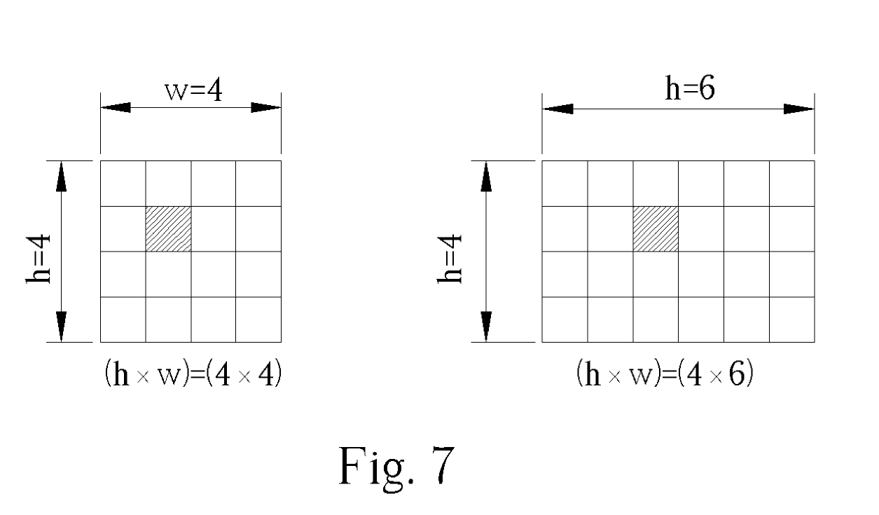

Please refer to FIG. 7. FIG. 7 is a schematic diagram of two data sections. Each square represents a pixel and for both data sections the 0th pixels are marked by the dark squares. The data section on the left is corresponding to the filter sizes of (h×w)=(4×4) and the one on the right is corresponding to the filter size of (h×w)=(4×6). However, one thing that should be noted is that at the boundaries of the original picture the data section might exceed the valid coordinates. In such case, the boundary conditions will need to be applied.

In the prior art, the first conventional method is low cost but slow, and the second conventional method is fast but demands high hardware complexity and power consumption. In contrast, the scaling method according to the present invention improves the drawbacks and has the advantages of both conventional methods, such as low hardware implementation complexity, low memory requirement, low power consumption and being applicable to real-time applications.

Those skilled in the art will readily observe that numerous modifications and alterations of the device may be made while retaining the teachings of the invention. Accordingly, the above disclosure should be construed as limited only by the metes and bounds of the appended claims.

1. A method for scaling a digital picture to generate a plurality of different size pictures comprising following steps:
(a) providing a scaling engine;
(b) loading a section of the digital picture to the scaling engine; and
(c) scaling the section loaded in step (b) to generate digital images of different sizes.

2. The method of claim 1 further comprising:
(d) repeating steps (b) and (c) until all sections of the digital picture are scaled so as to generate digital pictures of different sizes.

3. The method of claim 2 wherein step (c) comprises following steps:
(e) determining whether a digital picture to be generated will comprise a digital image generated from the section loaded in step (b);
(f) if so, scaling the section loaded in step (b) to generate the digital image in step (e); and
(g) if not, repeat step (e) for other digital pictures to be generated.

4. The method of claim 1 wherein the section loaded in step (b) is loaded to an interpolation filter of the scaling engine.

5. The method of claim 4 wherein size of the section loaded in step (b) is determined according to size of the interpolation filter.
